(19) United States
(12) Patent Application Publication
(10) Pub. No.: US 2024/0186539 A1
(43) Pub. Date: Jun. 6, 2024

(54) INDIVIDUAL CELL ASSEMBLY FOR A FUEL CELL STACK

(71) Applicant: CELLCENTRIC GMBH & CO. KG, Kirchheim/Teck-Nabern (DE)

(72) Inventors: Wayne DANG, Burnaby (CA); David ADAM, Burnaby (CA)

(21) Appl. No.: 18/556,604

(22) PCT Filed: Apr. 21, 2022
(86) PCT No.: PCT/EP2022/060480

§ 371 Date: Oct. 20, 2023

(30) Foreign Application Priority Data
Apr. 21, 2021 (DE) 10 2021 203 983.9

(51) Int. Cl. H01M 8/0273; H01M 8/0213; H01M 8/0221; H01M 8/0226; H01M 8/0258

(52) U.S. Cl. CPC H01M 8/0273; H01M 8/0213; H01M 8/0221; H01M 8/0226; H01M 8/0258

(57) ABSTRACT

The invention relates to a single cell assembly for a fuel cell stack having a framed membrane electrode assembly which comprises an electrochemically active region having two gas diffusion layers and a catalyst-coated membrane which are glued to a frame, with a bipolar plate which has flow-distributing and flow-guiding elements in a flow region corresponding to the electrochemically active region, wherein in an edge region of the bipolar plate surrounding the flow region, on at least one of its surfaces, a sealing groove for receiving a seal between the frame and the bipolar plate extends around the flow region. The single cell assembly according to the invention is characterized in that on at least one surface of the bipolar plate, between the sealing groove and the flow region, a receiving groove for a connection region between the frame and the membrane electrode assembly is arranged.

The invention relates to a single cell assembly for a fuel cell stack of the type defined in more detail in the preamble of claim 1.

Fuel cell stacks are known in principle from the prior art. In fuel cell stacks, a large number of individual cells are stacked on top of each other and, via bipolar plates, fluidically connected and electrically contacted with each other in order to connect the entire stack electrically in series. This design is generally known and common, in particular for PEM fuel cells. In particular each of the single cell assemblies has what is known as a membrane electrode assembly (MEA) and one of the bipolar plates. When these single cells are stacked on top of each other, the membrane electrode assembly is sandwiched between each two adjacent bipolar plates of adjacent single cell assemblies to form the entire stack.

DE 10 2017 219 507 A1 shows a method for manufacturing such a structure of a bipolar plate and a membrane electrode assembly, which are connected to each other via an injected sealant. The sealant also provides a seal between the individual cell assemblies during stacking. The structure is problematic in this case in that there is a greater thickness in the region of the sealant than in the other regions, so that when several individual cell assemblies are stacked, a higher contact pressure acts on the bipolar plates in this region than in the adjacent regions in which the flow-guiding and distribution structures, such as channels, for supplying mediums to the membrane electrode assembly are arranged. This uneven loading can lead to mechanical failure of the structure.

This applies in particular if the membrane electrode assembly is designed as a so-called framed membrane electrode assembly, in which a frame is provided in addition to the actual membrane electrode assembly, to which frame the individual layers of the membrane electrode assembly are glued. In the region where the frame and the individual layers of the membrane electrode assembly are glued together, the flexibility is then further impaired by the adhesive, so that a particularly high contact pressure is to be expected in this region. At the same time, this reduces the contact pressure in the region of the active surface and the flow-distributing or flow-guiding elements of the bipolar plate, so that there is a risk that medium will flow in the bypass between the seal and the flow region and thus not in the region of the electrochemically active surface of the membrane electrode assembly. Furthermore, the planar contact of the bipolar plate with the gas diffusion layer (GDL) of the membrane electrode assembly worsens. This increases the electrical resistance. This leads to more waste heat and lower efficiency.

Reference can also be made to EP 2 054 965 B1 for further prior art. Here, too, a bipolar plate is described in which the flow distribution is improved by appropriately designed flow-guiding elements.

It is now the object of the present invention to provide an improved single cell assembly with a framed membrane electrode assembly in which the problems mentioned at the outset are avoided or minimized.

According to the invention, this object is achieved by a device with the features of claim 1, and here in particular by the characterizing part of claim 1. Advantageous embodiments and developments result from the corresponding dependent claims.

In the single cell assembly according to the invention, a bipolar plate and a framed membrane electrode assembly with an electrochemically active region in the center on the one hand and a frame surrounding this region on the other hand are installed therein. The single cell assemblies are then stacked on top of each other in the same direction so that the surface of the membrane electrode assembly of one single cell assembly is in contact with the back of the bipolar plate of the adjacent single cell assembly. In the usual manner, a sealing groove is provided in the edge region of the bipolar plate on at least one of its surfaces, to accommodate a seal. In the framed membrane electrode assembly, this seal is between the frame and the bipolar plate. For this purpose, for example, a seal can be inserted in the sealing groove or an appropriate sealing material is applied to the bipolar plate and/or the frame so that during assembly this material comes to lie in the region of the sealing groove and reliably seals the stacked structure.

According to the invention, a further groove is now provided on at least one side of the bipolar plate between the sealing groove and a flow region comprising flow-distributing and flow-guiding elements. This serves as a receiving groove for a connection region between the frame and the membrane electrode assembly. This receiving groove thus lies outside the actual flow region, which comprises the flow field and distribution regions for distributing and collecting the mediums. It is thus arranged so that it corresponds to the connection region between the frame and the layers of the membrane electrode assembly. In this connection region, the frame is typically glued to a catalyst-coated membrane and two gas diffusion layers of the membrane electrode assembly. In the glued region, all four materials or layers overlap at least in portions. An adhesive is also provided in the connection region, which typically has less flexibility and compressibility than the layers bonded by it. In practice, therefore, a kind of bead is formed all around the electrochemically active surface of the membrane electrode assembly in its connection region with the frame. This leads to the problems described at the beginning. All these problems can now be avoided with the additional receiving groove. This creates space in the region of the bipolar plate for the bead of the connection region described above, so that despite the bead a relatively homogeneous contact pressure distribution can be achieved in the region of the bipolar plate, and here in particular in the flow region of the bipolar plate.

As already mentioned, the receiving groove for the connection region can be formed on at least one side of the bipolar plate. In practice, this then leads to a corresponding deformation of the connection region, since the one bipolar plate has the receiving groove and the other bipolar plate is flat. However, the material of the framed membrane electrode assembly is usually flexible enough in practice that this does not cause any further problems. Nevertheless, according to an particularly advantageous further development of the single cell assembly according to the invention, it can also be provided that the receiving groove is arranged correspondingly on both surfaces of the bipolar plate. Such a receiving groove, correspondingly arranged on both surfaces, then allows the connection region to be partially received in one adjacent bipolar plate and partially received in the other adjacent bipolar plate when stacking the single cell assemblies.

According to an advantageous embodiment, the depth of the receiving groove may be such that it is greater than the average thickness of the connection region between the frame and the membrane electrode assembly. In the case of a receiving groove, the depth of the receiving groove would be the depth of this receiving groove. In the case of two corresponding receiving grooves, which contact each other when stacking the bipolar plates, the total depth would then naturally be the sum of their depth, so that the groove on each surface of the bipolar plate would then only have to be half the depth otherwise required. In both cases, there is virtually no contact pressure in the portion of the connection region, or at least no increased contact pressure on the bipolar plates compared to the surrounding regions. A very homogeneous contact of the membrane electrode assembly in the flow region is thus possible. This leads to a uniform distribution of the reactants and to a very homogeneous and low electrical contact resistance between the membrane electrode assembly and the bipolar plate.

Another problem with such structures is that the individual layers of the membrane electrode assembly, namely the catalyst-coated membrane and the two gas diffusion layers starting from the connection region, occasionally delaminate over the lifetime of the fuel cell or the single cell assembly. In order to counteract such delamination, it can also be provided, in accordance with a particularly advantageous further development of the single cell assembly according to the invention, that a squeezing projection is provided in the receiving groove on at least one surface of the bipolar plate and in at least one portion of the circumference of the receiving groove around the flow region on its side facing the flow region. Such a squeezing projection now has the task of squeezing in the material of the framed membrane electrode assembly in certain regions and holding it together mechanically, in particular in the transition region where the three layers of the membrane electrode assembly are fanned out and glued to the frame. The height of the squeezing projection is smaller than the depth of the respective receiving groove in which it is arranged. In principle, therefore, the squeezing is achieved in a predetermined portion of the receiving groove without comparable high forces occurring as when the receiving groove is dispensed with completely. Due to the arrangement on the side of the flow regions, primarily the three layers of the membrane electrode assembly are held together and no significant contact pressure is exerted on the region additionally having the frame.

In accordance with an particularly advantageous further development of the single cell assembly according to the invention, the squeezing projection can be formed as a step on the bottom of the receiving groove. In particular, it is sufficient, in the case of two corresponding receiving grooves in the respective bipolar plate, if one of the groove bottoms has the corresponding squeezing projection. Further, it may be provided that the squeezing projection is located only adjacent to the flow region flow field, since here the connection region is particularly susceptible to delamination along the length of the structure. In the regions in which it is arranged, the squeezing projection can be of continuous design or consist of individual linearly successive portions, points or the like, since this is already sufficient to prevent delamination.

In order to counteract the discussed bypass effect of the medium around the electrochemically active surface of the membrane electrode assembly, which is adjacent to the flow field, it can now be further provided that between the receiving groove and the flow region a circumferentially closed flat region of both surfaces of the bipolar plate is provided, which is flush with or protrudes above the flow-distributing and flow-guiding elements. The flat circumferentially closed region thus surrounds the flow region like a kind of wall. This prevents flow or streaming of the supplied reactants in a bypass between the flow region and the sealing groove, around the electrochemically active region of the single cell assembly. In order not to adversely affect the distribution of contact pressure in the flow region, a height of the flat region corresponding to the flow-distributing and flow-guiding elements is sufficient. However, the design as a slight projection would be just as conceivable.

This is of particular advantage in the case of a generally known structure of bipolar plates comprising two layers, each of which has the flow regions for the anode side or the cathode side and a coolant flow field on their surface facing each other. The flow regions of the cathode side and/or the anode side, especially from both sides, would then be connected to the other surface of the layer by means of breaches, so-called “backfeed slots”, in the respective layer of the bipolar plate, in the region of which they are then connected to medium connection openings. This shifts the actual supply and removal of the mediums between the layers and thus virtually into the interior of the bipolar plate. As an example, reference can be made to the “backfeed slots” of WO 2008/061094 A1. By such a setup with “backfeed slots”, a flat region surrounding the entire flow region without interruption or a slight protrusion to prevent bypass flows is provided particularly efficiently.

The geometry created for the bipolar plate of the single cell assembly with framed membrane electrode assembly according to the invention initially appears relatively complex from the description. However, when the bipolar plate is made of a carbon-containing material in a plastic material matrix, its formation is relatively easy to implement because such bipolar plates or their halves are typically manufactured in a mold or die, so that the effort required for the additional insertion of a receiving groove, squeezing projection and/or of a projection to prevent bypass flow is relatively easy to implement.

Since such bipolar plates, which are based on a carbon-containing material, also represent the primary embodiment of the bipolar plate of the single cell assembly according to the invention, the advantages to be achieved far outweigh the increased manufacturing effort. The receiving groove thus has the advantage of reducing the required amount of material, because less volume is “filled” with material within the plate. For larger production quantities, this enables economically significant savings, while at the same time improving the properties of the plate.

Further advantageous embodiments of the single cell assembly for a fuel cell stack according to the invention result from the exemplary embodiments, which are described in more detail hereinafter with reference to the figures.

In particular:

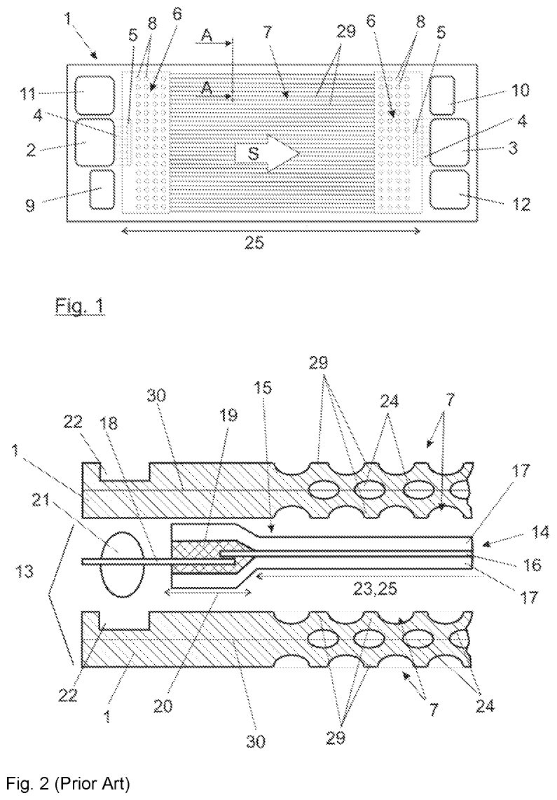

FIG. 1 shows a top view of a possible prior art bipolar plate;

FIG. 2 shows a structure of a single cell assembly and an additional bipolar plate according to section A-A in a variant according to the prior art, in the non-pressed state;

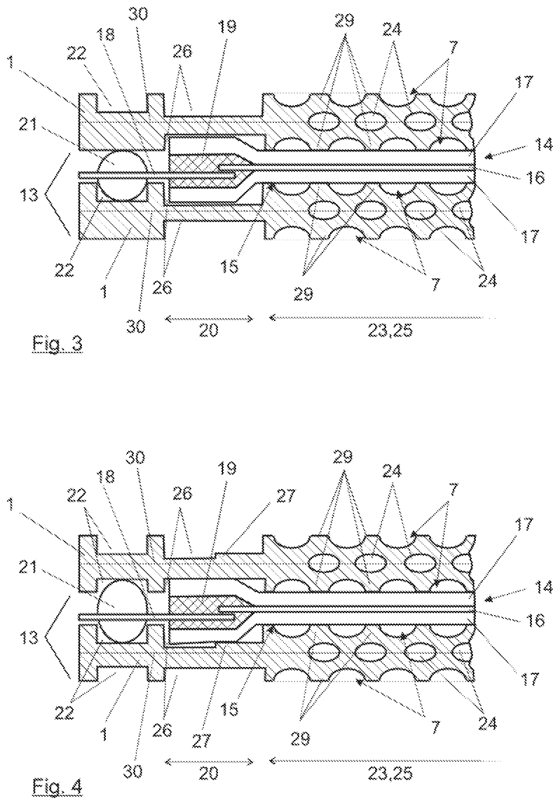

FIG. 3 shows a first possible embodiment of a single cell assembly according to the invention with an additional bipolar plate in the pressed state analogous to section A-A;

FIG. 4 shows a second possible embodiment of a single cell assembly according to the invention with an additional bipolar plate in the pressed state analogous to section A-A;

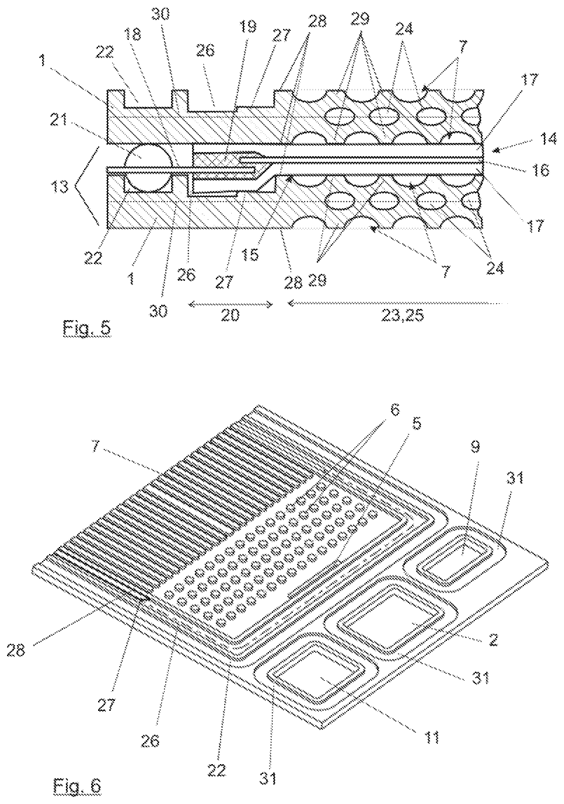

FIG. 5 shows a third possible embodiment of a single cell assembly according to the invention with an additional bipolar plate in the pressed state analogous to section A-A;

FIG. 6 shows a detail of a bipolar plate of the third embodiment in a three-dimensional view analogous to section A-A.

In the illustration of FIG. 1, a bipolar plate 1 is shown in a view from its cathode side, as an example. The structure corresponds, for example, to the prior art or is a schematic representation and serves here only to explain the individual regions. The real structure consists of two plate halves or layers, a cathode-side layer and an anode-side layer arranged behind it, which are joined together and enclose between them a cooling medium flow field 24 still visible in the following figures.

In the exemplary view shown here on the cathode side, air or oxygen is supplied via a medium connection opening 2, which serves here as a mediums inlet. This medium connection opening 2 runs through the entire fuel cell stack, which is not shown here, so that all individual cell assemblies 13 (cf. FIG. 2 ff) within the fuel cell stack can be supplied with oxygen via this medium connection opening 2. On the opposite side, a medium connection opening 3 can be seen, through which cathode exhaust gas flows out. In many cases, the medium connection openings 2, 3 are connected to an aperture 5 via channels 4 located on the back side or between the layers of the bipolar plate 1, which are shown in this representation. This aperture 5 is then in turn connected to a distribution region 6 with flow-distributing elements 8. In the flow direction S of the medium, marked with an arrow below the bipolar plate 1, the medium flows from the mediums connection opening 2, through which the oxygen flows, through channels 4 and via the aperture 5, also defined as the “backfeed slot”, into the distribution region 6. Through the open flow-distributing elements 8, which are open, and thus do not block but conduct the flow, and which are designed as knobs, the flow is distributed over the entire cross-section of the bipolar plate 1 and then flows through a flow field 7, which is adjacent to the active region of the single cell assembly 13. In the flow field 7, the flow is guided by parallel flow-guiding elements 29 in the form of ribs. It then enters another distribution region 6, and then flows through the aperture, also designated here as 5, and the channels 4 located between the plate halves of the bipolar plate 1, into the medium connection opening 3, where it flows out. The two distribution regions 6 and the flow field 7 form the flow region 25 on the respective surface of the bipolar plate 1.

With regard to the flow, the same applies to the medium connection openings 9, 10, which serve to supply and remove hydrogen on the opposite side of the bipolar plate 1. Between them lies the cooling medium flow field 24, which is supplied accordingly via the medium connection openings 11, 12.

The following FIGS. 2 to 5 now respectively show a schematically sketched detail of a single cell assembly 13, consisting of a bipolar plate 1 and a framed membrane electrode assembly 14 (MEFA—membrane electrode frame assembly), as well as an additional bipolar plate 1, in order to explain the effect of stacking the single cell assemblies 13. In the sectional view, it can be seen that the framed membrane electrode assembly 14 comprises, on the one hand, a membrane electrode assembly 15 (MEA). This is constructed from a catalyst coated membrane 16, which is also known as a CCM (catalyst coated membrane), and two gas diffusion layers 17 (GDL). In the edge region of the framed membrane electrode assembly 14, the catalyst-coated membrane 16 overlaps in portions a frame 18, which is typically formed from PEN (polyethylene naphthalate). An adhesive 19 which bonds the individual layers 16, 17 of the membrane electrode assembly 15 and the frame 18 together is indicated by cross-hatching in the illustration of FIG. 2. This connection region of the framed membrane electrode assembly 14, marked as 20 in FIG. 2, in practice has a greater thickness than the rest of the framed membrane electrode assembly 14. At the same time, the structure in the region of the adhesive 19 is not compressible or is less compressible than in the regions of the framed membrane electrode assembly 14 surrounding it, especially than the electrochemically active regions.

In the representation of the prior art in FIG. 2, the non-pressed structure is shown. When this is now pressed, a sealing material 21 is pressed between a sealing groove 22 of one bipolar plate 1 and a surface or optionally another sealing groove of the other bipolar plate 1, thus sealing the assembly to the outside. At the same time, the 2o electrochemically active surface, in the representation of FIG. 2 on the right of the connection region 20, which is designated here as 23, is pressed with the respective flow field 7 of the respective bipolar plate 1, wherein only a few channels and flow-guiding elements 29 of this flow field 7 can respectively be seen. Between the two flow fields 7 of the bipolar plate 1 and in its interior, a cooling medium flow field can also be seen, which is indicated by the reference sign 24 of some of its channels. A separation line 30 shows the usual structure of the bipolar plate 1 in practice, comprising two superimposed and mutually connected layers.

When the two bipolar plates 1 are pressed together as shown in FIG. 2, the sealing compound 21 seals the structure in the region of the sealing groove 22 and at the same time exerts very strong pressure on the connection region 20 of the framed membrane electrode assembly 14. This leads to a high mechanical load on the two bipolar plates 1. In the worst case, this can lead to mechanical impairment, cracks or the like, which are highly undesirable, since they could fluidically connect the anode side and the cathode side with each other and may, in addition, also endanger the tightness of the entire assembly. Another disadvantage is the much lower contact pressure in the region of the flow fields 7 than in the adjacent connection region 20, so that in the electrochemically active region 23 there is a risk that mediums will escape laterally due to the lower contact pressure in the region of the flow fields 20 and flow, for example, in the connection region or between the actual flow field 7 and the connection region. The electrochemically active surface is thus at least partially bypassed by the flowing mediums, which is a serious disadvantage with regard to the performance and, above all, the power density of a fuel cell composes of such single cell assemblies 13. Furthermore, as the contact pressure decreases, the electrical contact resistance between the bipolar plates 1 and the gas diffusion layer 17 also increases in an undesirable manner.

A solution to the above problems is provided by the structure shown in FIG. 3. Between the sealing groove 22 and the flow region 25 corresponding to the electrochemically active region 23, a receiving groove 26 for the connection region 20 of the framed membrane electrode assembly 14 is arranged on at least one of the surfaces of the bipolar plate 1, here preferably on both surfaces of each of the bipolar plates 1. This receiving groove 26 has the quite decisive advantage that the connection region, which effectively forms a surrounding bead all in the framed membrane electrode assembly 14, can be received in this receiving groove 26. Ideally, the depth of the receiving groove 26 is such that no or hardly any contact pressure is exerted on the connection region 20, so that the most homogeneous contact pressure possible can be achieved between the flow fields 7 in the flow region 25 on the one hand and the electrochemically active region 23 of the membrane electrode assembly 15 on the other. This ensures that the mediums are distributed as evenly as possible within the regions intended for them, as well as a homogeneous and low electrical contact resistance.

In practice, delamination of the structure of the membrane electrode assembly 15 occasionally occurs. In most cases, this starts in the connection region 20, specifically in the region where the three layers 16, 17 of the membrane electrode assembly 15 are fanned out in order to be connected to the frame 18 via the adhesive 19. In this region, where in principle there is a gap between the two gas diffusion layers 17 and the catalyst-coated membrane 16, the problem of delamination often starts. To counteract this, in the embodiment variant of the single cell assembly 13 according to FIG. 4, a squeezing projection 27 is provided at the bottom of at least one of the receiving grooves 26. The squeezing projection 27 is formed in such a way that it has a significantly smaller height than the depth of the receiving groove 26, so that it mechanically holds the three layers of the membrane electrode assembly 24 together, while not causing the problem of higher contact pressure in this region than in the adjacent regions of the flow fields 7, as described in the prior art mentioned at the beginning.

As a further design variant, FIG. 4 shows a bilateral sealing groove 22.

As already mentioned, the more homogeneous contact pressure in the region of the flow fields 7 already significantly reduces the risk of a possible bypass flow around the flow fields 7. Nevertheless, a complementary variant of the bipolar plate 1 of the single cell assembly 13, shown in FIG. 5, may provide that a planar region 28 is provided which continuously surrounds the flow region 25. This flat region 28 can be used to seal the entire flow region from the outside, thus preventing mediums from escaping into a bypass flow around the flow fields 7 or the flow region 25. This flat region 28 is provided on both sides. It may also be formed on one of the sides as a completely flat surface of the edge of the bipolar plate 1, as indicated in FIG. 5. However, any combination of all the individual aspects shown in FIGS. 3 to 5 and/or described on the basis of the same is equally conceivable.

Finally, in the representation of FIG. 6, a three-dimensional detail of a bipolar plate 1 is shown in a viewing direction directed toward the cathode side. Two of the medium connection openings, here medium connection openings 11 and 2, can be seen, as also shown in the representation of FIG. 1. They are each surrounded by their own sealing groove 31. The medium connection opening 2 is connected to the aperture 5 via the channels 4, which are not visible in this case, because they run inside the bipolar plate 1, which aperture is formed here by three openings. This is followed, in the medium flow direction, by the distribution region designated as 6 with its point-like structures 8 and then by the flow field 7. The entire flow region 25 is surrounded by the sealing groove 22 in the edge region of the bipolar plate 1. This is then followed inwards by the receiving groove 26 and the flat region designated 28, as a bypass barrier. In the embodiment example shown here, the squeezing projection 27 is visible throughout adjacent to the actual flow money 7. It can optionally be continued around the distribution region 6, as indicated here by the dashed line 32.

What is claimed is:

1. A single cell assembly for a fuel cell stack having a framed membrane electrode assembly which comprises an electrochemically active region having a two gas diffusion layers and a catalyst-coated membrane which are glued to a frame, with a bipolar plate which has flow-distributing and flow-guiding elements in a flow region corresponding to the electrochemically active region, wherein, in an edge region of the bipolar plate surrounding the flow region, on at least one of its surfaces, a sealing groove for receiving a seal between the frame and the bipolar plate extends around the flow region, wherein,
on at least one surface of the bipolar plate, between the sealing groove and the flow region, a receiving groove for a connection region between the frame and the membrane electrode assembly is arranged, and wherein
the receiving groove is arranged correspondingly on both surfaces of the bipolar plate).

2. The single cell assembly according to claim 1,
wherein
a depth of the receiving groove, or when two corresponding receiving grooves face each other when stacking the bipolar plates, their common depth is equal to or greater than the average thickness of the connection region between the frame and the membrane electrode assembly.

3. The single cell assembly according to claim 1,
wherein
in the receiving groove on at least one of the surfaces of the bipolar plate and on at least one portion of the receiving groove around the circumference of the flow region on its side facing the flow region, a squeezing projection is provided, the height of which is smaller than the depth of the respective receiving groove.

4. The single cell assembly according to claim 3,
wherein
the squeezing projection is formed as a step on the bottom of the receiving groove.

5. The single cell assembly according to claim 1,
wherein
the squeezing projection is arranged in only one of the receiving grooves.

6. The single cell assembly according to claim 3,
wherein
the squeezing projection is arranged only adjacent to the flow field of the flow region.

7. The single cell assembly according to claim 3,
wherein
the squeezing projection comprises a sequence of discrete individual projections.

8. The single cell assembly according to claim 1,
wherein,
between the receiving groove and the flow region, a circumferentially closed flat region of both surfaces of the bipolar plate is provided, which terminates flush with the flow-distributing and flow-guiding elements or projects beyond them.

9. The single cell assembly according to claim 1,
wherein
the bipolar plate is formed of a carbon-containing material within a plastic material matrix.

10. The single cell assembly according to claim 2,
wherein
in the receiving groove on at least one of the surfaces of the bipolar plate and on at least one portion of the receiving groove around the circumference of the flow region on its side facing the flow region, a squeezing projection is provided, the height of which is smaller than the depth of the respective receiving groove.

11. The single cell assembly according to claim 3,
wherein
the squeezing projection is arranged in only one of the receiving grooves.

12. The single cell assembly according to claim 4,
wherein
the squeezing projection is arranged in only one of the receiving grooves.

13. The single cell assembly according to claim 4,
wherein
the squeezing projection is arranged only adjacent to the flow field of the flow region in the receiving groove.

14. The single cell assembly according to claim 5,
wherein
the squeezing projection is arranged only adjacent to the flow field of the flow region in the receiving groove.

15. The single cell assembly according to claim 4,
wherein
the squeezing projection comprises a sequence of discrete individual projections.

16. The single cell assembly according to claim 5,
wherein
the squeezing projection comprises a sequence of discrete individual projections.

17. The single cell assembly according to claim 2,
wherein,
between the receiving groove and the flow region, a circumferentially closed flat region of both surfaces of the bipolar plate is provided, which terminates flush with the flow-distributing and flow-guiding elements or projects beyond them.

18. The single cell assembly according to claim 3,
wherein,
between the receiving groove and the flow region, a circumferentially closed flat region of both surfaces of the bipolar plate is provided, which terminates flush with the flow-distributing and flow-guiding elements or projects beyond them.

19. The single cell assembly according to claim 2,
wherein
the bipolar plate is formed of a carbon-containing material within a plastic material matrix.

20. The single cell assembly according to claim 3,
wherein
the bipolar plate is formed of a carbon-containing material within a plastic material matrix.
